(19) United States
(12) Patent Application Publication
(10) Pub. No.: US 2026/0003383 A1
(43) Pub. Date: Jan. 1, 2026

(54) DEVICE FOR OPERATING A BUILT-IN KITCHEN APPLIANCE

(71) Applicant: BORA - Vertriebs GmbH & Co KG, NIEDERNDORF (AT)

(72) Inventors: Christof DESSL, Niederndorf (AT); Matthias KARL, Niederndorf (AT); Simon ENDRES, Niederndorf (AT); Josef MÜLLER, Niederndorf (AT); Tim SCHWENZER, Niederndorf (AT)

(21) Appl. No.: 19/254,942

(22) Filed: Jun. 30, 2025

(30) Foreign Application Priority Data
Jul. 1, 2024 (DE) 10 2024 206 141.7

(51) Int. Cl. G05G 1/12; G05G 1/10

(52) U.S. Cl. CPC G05G 1/12; G05G 1/105

(57) ABSTRACT

An operating device for operating a hob system includes an operating element and a fastening device for fastening the operating element to a kitchen furniture. The fastening device includes a plurality of pin-shaped elements and a fixing device. The plurality of the pin-shaped elements each having a partially threaded portion, the fixing device having a nut with one or more threaded fixing portions, which are formed fitting to the partially threaded portions in such a way that the nut cooperates with a plurality of the partially threaded portions.

The contents of German patent application DE 10 2024 206 141.7 are incorporated by reference.

The invention relates to an operating device for operating a built-in kitchen appliance. The invention also relates to a built-in kitchen appliance comprising an operating device of this type. Finally, the invention relates to a method for assembling an operating device for a built-in kitchen appliance.

Hobs are typically operated via touch-sensitive control systems (known as touch panels) or control knobs. Corresponding hob systems are known for example from DE 10 2009 025 038 A1, EP 1 944 553 B1 and DE 10 2016 217 724 A1. A control knob for operating a hob is known from DE 20 2009 009 727 U1.

An object of the invention is to improve an operating device for operating a built-in kitchen appliance (operating device). In particular, an object of the invention is to provide an operating device for a built-in kitchen appliance which makes better, in particular simpler and/or more reliable, installation possible.

This object is achieved by an operating device according to claim 1.

In one aspect, the operating device has a fastening device for fastening an operating element to a kitchen furniture, said device having a holder, with a plurality of pin-shaped elements, and a fixing means which cooperates with a plurality of the pin-shaped elements.

Details of the cooperation of the fixing means with a plurality of the pin-shaped elements are based in particular on the intended use of the operating device, in particular its intended arrangement in or on a kitchen furniture.

It should also be noted that the application comprises various alternatives for the operating device, at least some of which do not make use of all features of the subject matter of claim 1. The features of claim 1 are not to be understood as mandatory features for any subsequent and/or divisional applications which may be filed later. They may in particular be omitted or be configured in an alternative manner in alternative embodiments of the operating device.

In general, the operating device has a fastening device, the fastening device having at least one pin-shaped element, relative to which, in particular in the direction of its longitudinal axis, at least one fixing means can be fastened.

The holder can be used to hold the operating element.

Preferably, the operating device may be configured as a control knob.

In one aspect, the operating device has exactly one fixing means, which cooperates with a plurality of the pin-shaped elements. In particular, it may have a single fixing means.

The fixing means may in particular comprise a threaded nut.

The pin-shaped elements are also referred to as pin-shaped extensions.

Threaded bolts in particular are suitable as pin-shaped elements. The pin-shaped elements may each have one or more partially threaded portions, in particular on their outer circumferential faces and/or on their inner circumferential faces. It is also possible for only a subset of the pin-shaped elements to have threaded portions while another subset of the pin-shaped elements do not have any threaded portions.

The pin-shaped extensions may also be configured as metal rods, in particular as threaded rods, in particular as fine-threaded metal rods.

This can make it easier to attach the fixing means.

A variant where all pin-shaped elements have threaded portions, with which the fixing means cooperates, leads to a particularly stable arrangement of the fastening device on the kitchen furniture.

The operating element may in particular have a circular, a circular annular or a polygonal cross section.

The operating element may in particular be mounted rotatably on the fastening device. It may in particular comprise a component mounted rotatably relative to the fastening device.

The rotatably mounted component of the operating element may in particular have a circular annular cross section.

The operating element may comprise an electronic control unit. In particular, it may comprise the entire electronic control unit for operating one or more functions of the built-in kitchen appliance.

The electronic control unit may be arranged entirely in front of or outside the kitchen furniture. The electronic control unit is preferably arranged entirely within the operating element. The electronic control unit may preferably comprise a circuit board. In the following, the term “circuit board” is understood to refer in particular to an electronic control unit as such, even if it does not necessarily comprise a circuit board.

The operating element may in particular comprise a circuit board. The circuit board may in particular be circular and annular. It may in particular have a width of at most 3 cm, in particular at most 2 cm, in particular at most 1 cm. This width is measured in the radial direction.

The circuit board may in particular be arranged in a cavity, in particular an encapsulated cavity, in particular a liquid-tight encapsulated cavity, of the operating element.

The operating element may have one or more magnets. These may be used for mounting the operating element. In particular, they may make self-aligning positioning of the operating element possible.

By way of one or more magnets, haptic feedback when the operating element is rotated is also possible.

The operating element may have one or more Hall sensors.

The operating element may be mounted mechanically or magnetically, in particular on the holder. It may in particular have one or more latch elements, in particular comprising ball pressure pieces.

The operating element may comprise a lighting device. The lighting device may comprise at least one lighting means, in particular one or more light-emitting diodes (LEDs).

The operating element may have one or more transparent regions and/or one or more roughened regions and/or one or more polished regions. In this context, a region is understood to mean in particular a simply connected surface.

The operating element may in particular have a hollow axle.

Further aspects and details of the operating element may be found in the description of the embodiments.

In one aspect, the fastening device comprises at least 2, preferably 3 or more, pin-shaped elements. A higher number of pin-shaped elements can lead to a more stable arrangement of the fastening device on a furniture front.

Preferably, the fastening device has at most 6, in particular at most 4, preferably 3 or 2 pin-shaped elements or exactly one pin-shaped element. A smaller number of pin-shaped elements leads to simpler and in particular faster assembly.

In one aspect, the fastening device or parts thereof may be interchangeable. In particular, pin-shaped elements of different lengths can be provided. This allows simple adaptation of the fastening device to the ceiling of a fastening surface, in particular a front panel of a kitchen furniture.

The pin-shaped elements may be formed integrally with the holder. This can lead to particularly advantageous stability. This can also facilitate manufacture of the fastening device. Alternatively, for this purpose the pin-shaped elements may be screwable into the holder or be passed through openings in the holder, inserted into clearances in the holder, or pushed onto the holder.

The pin-shaped elements may also be formed separately from the holder. In particular, they can be configured to clamp the holder to a furniture front.

The face of the fastening device facing a user during the intended use, in particular in the intended arrangement, of the kitchen appliance is referred to in the following as the front face, and the opposite face, remote from the user, is also referred to as the rear face. The front face of the operating device forms in particular the visible face thereof.

In one variant, the fixing means comprises a plurality of nuts. The fixing means may in particular comprise a separate nut for each of the pin-shaped elements for screwing onto the pin-shaped element.

Cap nuts in particular may be used as fixing means.

In one variant, the pin-shaped elements each have a latch portion. This latch portion may be latched to a matching counter latch portion in the fixing means. The latch connection may be configured to be reversibly removable or irreversible, in particular not removable without destruction, in particular in the manner of a reversibly removable or non-removable cable tie.

The fixing means may also include latch elements. Latch tabs, for example, may be used as locking elements. The latch elements may preferably be reversibly removable. The latch element may consist of a plurality of parts.

The fixing means may be equipped with wave springs. In this way, a contact pressure can be provided.

In one aspect, the holder for the operating element may be configured as an annular plate on which the operating element is arranged in a reversibly removable or fixed manner.

The annular plate may, in particular on its rear face, form a contact surface for contact with a furniture front. This results in a particularly stable, reliable arrangement of the operating device on the furniture front.

The plate may be formed relatively thin. It may in particular have a thickness of at most 5 mm, in particular at most 3 mm, in particular at most 1 mm. A thicker configuration can result in a more stable configuration.

The holder may be made of metal or plastics material.

The holder may in particular have a circular, a circular annular or a polygonal cross section. The cross section of the holder is preferably adapted to the cross section of the operating element. Preferably, the holder is not visible, at least from the front, when the operating element is in place.

The holder may in particular comprise mechanical and/or magnetic holding means for holding the operating element. The holding means may in particular comprise holding tabs, openings, screws, permanent magnets or ferromagnetic elements for cooperation with permanent magnets. Combinations of elements of this type are also possible.

The operating element may be arranged on the holder in a removable, in particular reversibly removable, manner.

The reversible removability of the operating element allows it to be removed when not in use or for cleaning purposes. The removability of the operating element can also be used as a child safety feature.

The operating element may also be arranged fixed on the holder.

A fixed arrangement of the operating element on the holder is understood to mean in particular that the operating element cannot be removed from the holder without tools and/or without being destroyed.

In one aspect, the partially threaded portions may together form portions of a single thread. In particular, they may be configured in such a way that their threaded parts are aligned along a single, continuous thread line.

The threaded fixing portions of the nut may in particular form a single, continuous thread. This can facilitate screwing the nut onto the pin-shaped extensions with the partially threaded portions.

In one aspect, the partially threaded portions may be identical in configuration. In particular, the pin-shaped extensions may be identical in configuration. This can simplify production.

In the case of identically formed pin-shaped extensions, the partially threaded portions need not form sub-portions of a continuous thread. However, this is still possible.

In a further aspect, the nut has a number and arrangement of threaded fixing portions matching the number and arrangement of the partially threaded portions.

For example, in the case of three threaded bolts, the nut may have three threaded fixing portions. In general, the number of threaded fixing portions may be equal to the number of threaded bolts.

The threaded bolts may be arranged uniformly distributed in the circumferential direction on or at the holder.

The threaded fixing portions of the nut may each extend over angular ranges smaller than the angular distance between adjacent threaded bolts. This makes it possible to push the nut on.

The threaded fixing portions may in particular be configured in such a way that they can each be brought into engagement with exactly one of the partially threaded portions.

The fixing means may also be fastened to the pin-shaped extensions in the manner of a bayonet lock. This can make it possible to fasten the fixing means to the pin-shaped extensions with a single movement. For this purpose, it may be moved in particular into an over-dead-centre position.

In a further aspect, the fastening device has at least one feedthrough for a signal-transmitting element.

The feedthrough may be a cavity, in particular a cable duct, in particular for feeding a signal cable through a furniture front.

In one aspect, the feedthrough may be formed in one, two, three, or all of the pin-shaped extensions. In principle, the feedthrough may also be formed by the pin-shaped extension itself. The pin-shaped extension may also delimit the feedthrough in portions, in particular at least on one side.

The pin-shaped extension may for example be groove-shaped, semi-tubular or tubular.

In particular, it is possible to integrate a cable feedthrough into one or more, in particular all, of the pin-shaped extensions.

Preferably, a signal-transmitting element in the form of at least one cable and/or at least one circuit board may be arranged in the feedthrough. The at least one circuit board may be elongate, in particular with a length-to-width ratio of at least 2, in particular at least 4, in particular at least 6. The at least one circuit board may have at least one connection means, in particular a plug-in connection means, in particular at least one socket and/or at least one plug, in particular an edge card connector, in particular for reversibly connecting to another, in particular adjoining, signal-transmitting element. Preferably, at least one connection means is provided at both ends of the elongate circuit board. The connection means may be integrally connected, in particular soldered, to the circuit board.

The at least one signal-transmitting element may be configured to supply power, in particular to lighting, in particular to LED lighting, in particular to an LED driver, and/or to transmit data, in particular control data for controlling a hob and/or an extractor hood, and/or to monitor the functionality of the operating device. For this purpose, at least one line may be provided for each of the aforementioned functions.

Preferably, the at least one circuit board is fastened to the fastening device, in particular to the at least one extension, in particular positively, in particular by latching, and/or in a material fit, in particular by gluing, and/or non-positively and/or in a reversibly removable manner.

The at least one circuit board may comprise electronic parts and/or, in particular exclusively, at least one electrical line.

The feedthrough may be configured in such a way that the signal-transmitting element is insertable or is inserted into the circuit board and/or the feedthrough in the longitudinal direction. In this case, the feedthrough may be tubular and thus enclose the cavity formed thereby the whole way around.

Alternatively or additionally, the feedthrough may be configured in such a way that the signal-transmitting element is insertable or is inserted into the circuit board and/or the feedthrough in the transverse direction. In this case, the feedthrough may have a lateral opening, in particular a longitudinal slit, and thus may only partially enclose the cavity formed thereby.

The feedthrough may be formed in one or more of the pin-shaped extensions, in particular in all of the extensions or in a number reduced from the total number of extensions. For example, if there are a plurality of extensions, in particular three, exactly one extension may have a feedthrough, in particular with a circuit board arranged therein.

The feedthrough and the circuit board may therefore be designed for longitudinal insertion and/or lateral insertion of the circuit board into the feedthrough.

The pin-shaped extensions may themselves form signal-transmitting elements. This can result in saving on cables. Furthermore, a particularly reliable signal connection to the operating element can be ensured.

In a further aspect, the fixing means comprises a support ring for supporting the pin-shaped extensions.

The fixing means may in general be made up of a plurality of parts, in particular two parts.

In a further aspect, the support ring may be resilient.

This makes it possible to exert a contact pressure on the rear face of a board, in particular of a furniture front.

The support ring may in particular be configured in the manner of a plate spring. It may also comprise a plurality of resilient elements, for example leaf springs, plate springs or wave springs.

In a further aspect, the nut is latchable to the support ring. It may in general be releasably fixable to the support ring.

For latching the nut to the support ring, one or more, in particular three, latch tabs may be provided. The latch tabs may have retaining lugs, which can in particular engage around an edge of the support ring. The latch tabs may in particular be spring-mounted. The latch tabs may in particular be arranged on the outer face of a slot. In this case, they can be connected to the support ring via thin webs. The webs may in particular have a width of at most 5 mm, in particular at most 3 mm.

In a further aspect, the nut is mounted on the support ring rotatably relative to the support ring. This facilitates attaching the nut to the fastening device, in particular to the pin-shaped extensions. When the nut is being screwed onto the pin-shaped extensions, they may be supported, in particular by the support ring, against a load transverse to their axis.

In a further aspect, the nut may be spring-mounted on the support ring in the screwing direction. This makes it possible to achieve a specific contact pressure of the support ring against the rear face of a furniture front.

In a further aspect, the fastening device, in particular the fixing means, may comprise plastics material components. In particular, it is possible to form all components of the fastening device from plastics material. This can make particularly simple production possible.

The fastening device may also include metal, in particular stainless metal, components. This can result in particularly high stability and load-bearing capacity.

A built-in kitchen appliance can be improved by an operating device according to the invention. The built-in kitchen appliance may in particular be a hob, an extractor hood, or a combination appliance with a hob and an extractor hood. This list is not intended to be exhaustive.

In an independent aspect, which constitutes a separate subject matter of the invention but may optionally be combined with the other features, the operating device may have a central clearance, in particular on the front face of the operating device. In particular, this aspect is advantageous even without the fastening device, in particular without the one or more pin-shaped elements and/or the fixing means.

The central clearance may pass through the fastening device and/or the operating element. The central clearance is preferably configured in such a way that the kitchen furniture, in particular a kitchen wall, in particular a kitchen front, is uncovered by the operating device in a front view. The central clearance is preferably round, in particular circular, in a plan view.

Preferably, the operating element, in particular a rotatably mounted component of the operating element, in particular the knob cover, and/or a circuit board, in particular a circuit board with at least one lighting means, and/or at least a part of the fastening device, are annular, in particular circular and annular. In particular, this makes it possible to provide the central clearance. Preferably, the rotatably mounted component of the operating element encloses the central clearance annularly, in particular circularly and annularly.

In an independent aspect, which forms a separate subject matter of the invention but may optionally be combined with the other features, the operating device may have at least one lighting means, in particular an LED, in particular a white LED, an RGB LED and/or an RGBW LED. A primary light emission direction of the lighting means may be orientated, at least in one directional component, in particular exclusively, towards a rear face and/or a front face and/or a side surface of the operating device. This advantageously ensures that the lighting can be particularly uniform, in particular with a reduction in differences in intensity.

In an independent aspect, which forms a separate subject matter of the invention but may optionally be combined with the other features, the operating device, in particular the operating element and/or the fastening device, may have at least one reflector for reflecting the light emitted by the at least one lighting means, in particular in the direction of a front face and/or a side surface of the operating device. The at least one lighting means may be orientated in such a way that a primary radiation direction of the emitted light is orientated in the direction of the front face and/or the rear face and/or a side surface of the operating device. The reflector may be flat or curved, in particular concave and/or convex. In a curved configuration, the lighting can be made more uniform. In principle, the at least one reflector has the advantage that a particularly compact configuration can be achieved and/or a particularly targeted influence on the light distribution is made possible and/or the beam path of the light can be configured in a particularly targeted manner even in a small space.

In addition to the reflector, a masking means, in particular a masking ring, may be provided, in particular one made of opaque plastics material. The masking means is also referred to as a barrier. The masking means may delimit the at least one lighting means outwards and/or inwards and/or to one side and/or prevent the lighting means from radiating in an undesired direction, in particular sideways. The light is preferably radiated, in particular guided, only to the desired region, in particular of a light guide. Preferably, the light is to be radiated, in particular guided, forwards.

Preferably, the operating device may be configured in such a way that the light emitted by the at least one lighting means is emitted forwards and/or inwards and/or outwards, in particular with respect to an annular component of the operating device, in particular on the inner and/or outer surface of a light guide.

Preferably, the at least one lighting means may emit the light counter to the direction in which it is emitted, in particular via the light guide body, from the operating device.

In a preferred aspect, the central clearance may open up a view of the kitchen furniture. Alternatively, a decorative element may be arranged in the central clearance, and preferably has and/or corresponds to the surface quality of the kitchen furniture, in particular of the furniture wall, in particular of the furniture front, in particular of the furniture wall to which the operating device is attached. The decorative element is preferably plate-shaped, in particular disc-shaped. It may be connected to the operating device non-positively and/or positively and/or in a material fit, in particular by gluing.

The operating device may have a plurality of lighting means which can be controlled separately from one another, in particular for emitting light of different brightness and/or different colours.

A lighting control system may be configured in particular to output information concerning the currently outputted heating power, the fan power of the extractor hood, the cooking zone temperature and/or the operating state of the hob and/or extractor hood to the user via the at least one lighting device. For this purpose, the lighting control system may be in signal communication with and/or be formed integrally with a control system of the at least one hob and/or of the extractor hood.

The operating device preferably comprises a light guide body, which preferably is annular, in particular circular and annular, and/or functions as a diffuser and/or as a focus element. The light guide body is preferably a component of the operating element and/or the fastening device. The light guide body can be illuminated by means of the at least one lighting means. The light guide body preferably delimits the central clearance, in particular the whole way around. As a result, the central clearance can be lit by means of the at least one lighting means via the light guide body. The information outputted to the user by means of the lighting is therefore particularly easy to perceive, in particular in the region in which the user makes a user input via the operating element. The central region is therefore at the focus of the user's perception and is therefore particularly suitable for transmitting corresponding information.

Alternatively or additionally, the light guide body may delimit an outer circumference of the operating element and/or fastening device at least in portions, in particular the whole way around.

In particular, the at least one lighting means may be configured in such a way that the light guide body can be lit at an inner face and an outer face and/or at the inner circumference and outer circumference of the operating device independently of one another.

The light guide body may be configured in one part or in a plurality of parts.

The rotatable parts of the operating element, in particular of the knob cover, may be mounted using roller bearings, in particular ball bearings, and/or using plain bearings.

Preferably, a connection of at least one bearing to the rotatable part, in particular to the knob cover, is formed by a non-positive connection, in particular by a press fit, and/or by means of a pressure piece and/or magnetically.

The rotational position between the rotatable part of the operating element, in particular the knob cover, and a base body, in particular the fastening device, is preferably detected by means of a Hall sensor. Other sensors for detecting a rotational movement are also suitable, for example a rotary encoder plus coding disk and/or a sensing means and/or the like.

Preferably, the fastening device, in particular the threaded fixing portions and/or the partially threaded portions, is configured in such a way that tilting of the joining partners, in particular of the threaded fixing portions and partially threaded portions, is reliably prevented. For this purpose, for example at least one threaded portion may be formed interrupted, in particular slitted, with longitudinal slits at least in part, in particular in the circumferential direction.

Preferably, the operating device is configured to be assembled blindly, in other words in such a way that the fastening device can be assembled and/or locked, in particular tensioned, without direct visual contact, in particular in such a way that the pin-shaped elements and the fixing means can be interconnected without direct visual contact.

A further object of the invention is to provide an improved hob system.

This object is achieved by a hob system comprising an operating device according to the above description. The hob system may be developed with at least one of the features described above in connection with the operating device. The advantages of the hob system correspond to the advantages of the operating device. The hob system preferably comprises at least one hob, in particular with at least one, in particular at least two, cooking zones, and/or at least one extractor hood, in particular a downdraft extractor.

The operating device is preferably configured to control the hob system, in particular the at least one hob, in particular the at least one cooking zone, and/or the at least one extractor hood. For this purpose, the at least one operating device may be in signal communication with the hob system, in particular the at least one hob and/or the at least one extractor hood. The at least one extractor hood is preferably configured as a downdraft extractor or as a device for extracting cooking fumes downwards, in particular through a cooking fume inlet opening of the extractor hood.

A further object of the invention is to provide an improved furniture system.

This object is achieved by a furniture system, comprising a kitchen furniture and an operating device as described above attached to the kitchen furniture, in particular to a furniture wall, in particular to the furniture front. Preferably, the operating element is fastened to the kitchen furniture, in particular to the furniture wall, in particular to the furniture front, by means of the fastening device. The advantages of the furniture system correspond to the advantages of the operating device or hob system described above. Preferably, the furniture system is developed with at least one of the features described above in connection with the operating device and/or the hob system.

Particularly preferably, the kitchen furniture, in particular the furniture wall, in particular the furniture front, is uncovered by the operating device in the region of the central clearance, in particular in a front view.

A further object of the invention is to improve a method for assembling an operating device for a built-in kitchen appliance.

This object is achieved by a method comprising the following steps:
providing an operating device, in particular according to the preceding description, comprising a fastening device with a plurality of pin-shaped extensions,
drilling holes in a kitchen furniture,
the number and arrangement of the holes corresponding to the number and arrangement of the pin-shaped extensions of the fastening device.

Further advantages and details of the invention will be apparent from the description of example embodiments with reference to the drawings. Individual aspects of the example embodiments, taken individually and in conjunction with one another, may form aspects of the invention or form a separate invention. In particular, details of different example embodiments may be combined with one another as desired. In the drawings:

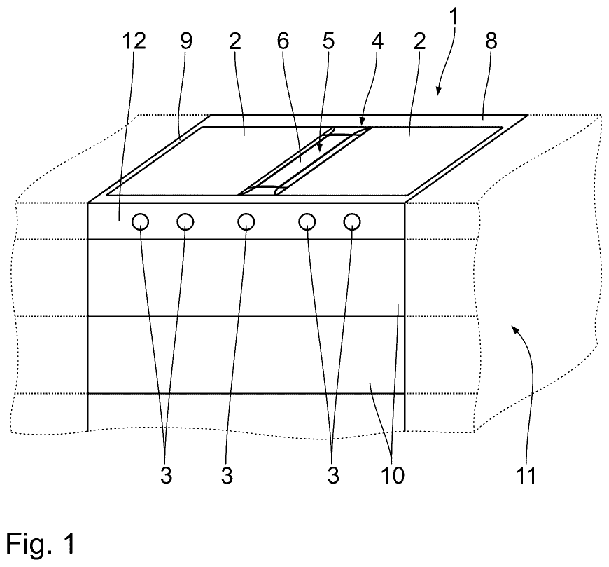

FIG. 1 is a schematic view of a hob system with two hobs and an extractor fan in the form of a downdraft extractor with a plurality of operating devices for operating the hob system,

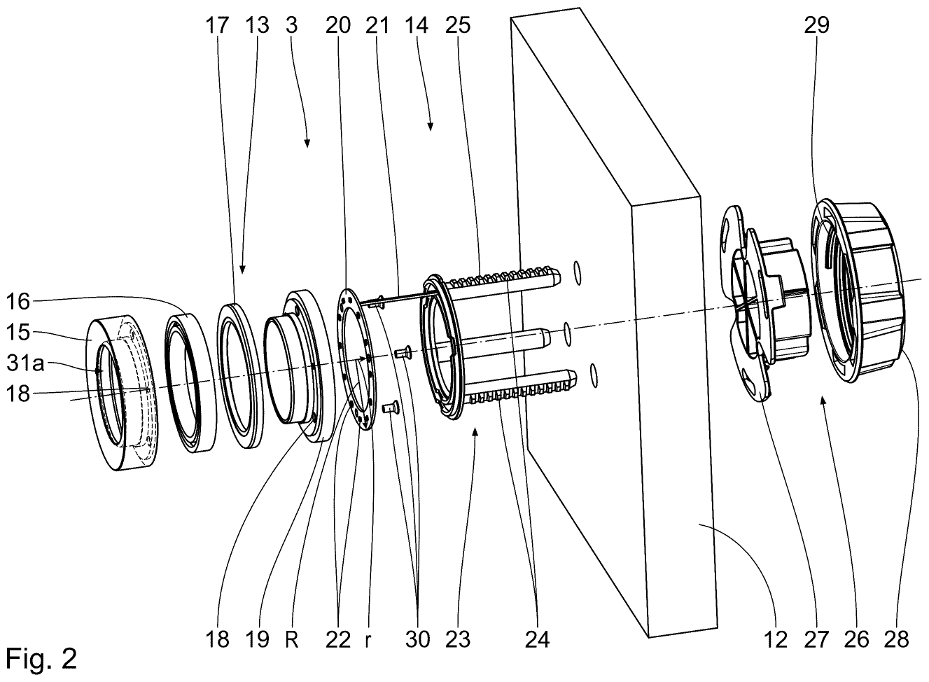

FIG. 2 is an exploded view of one of the operating devices of FIG. 1,

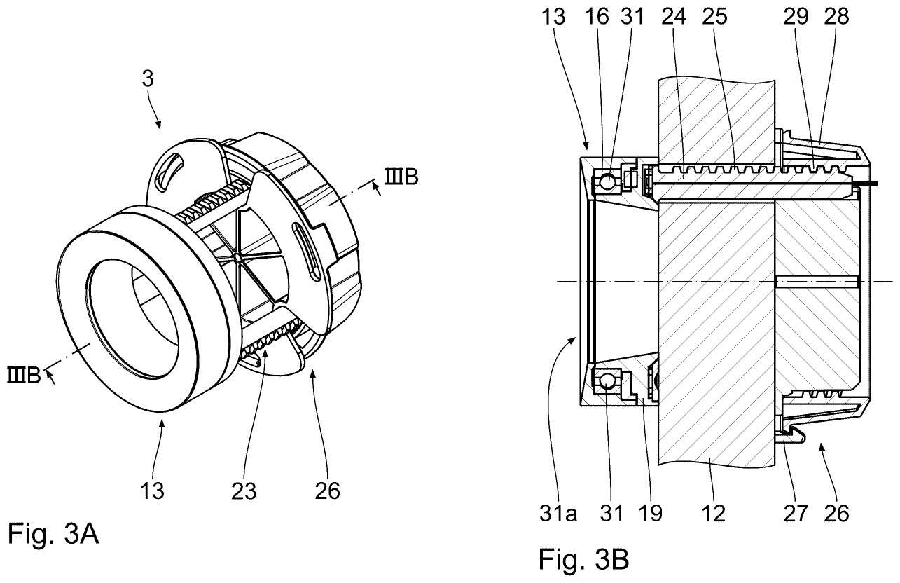

FIG. 3A is a perspective view of the operating device of FIG. 3,

FIG. 3B is a sectional view of the operating device along the section line IIIB-IIIB in FIG. 3A,

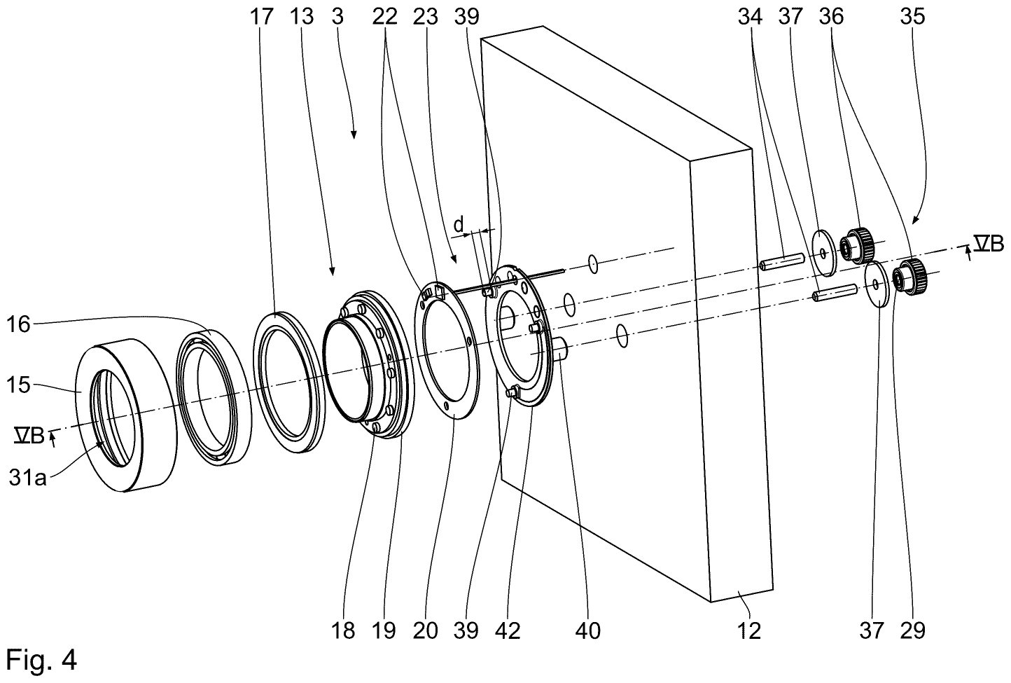

FIG. 4 is an exploded view of another variant of an operating device,

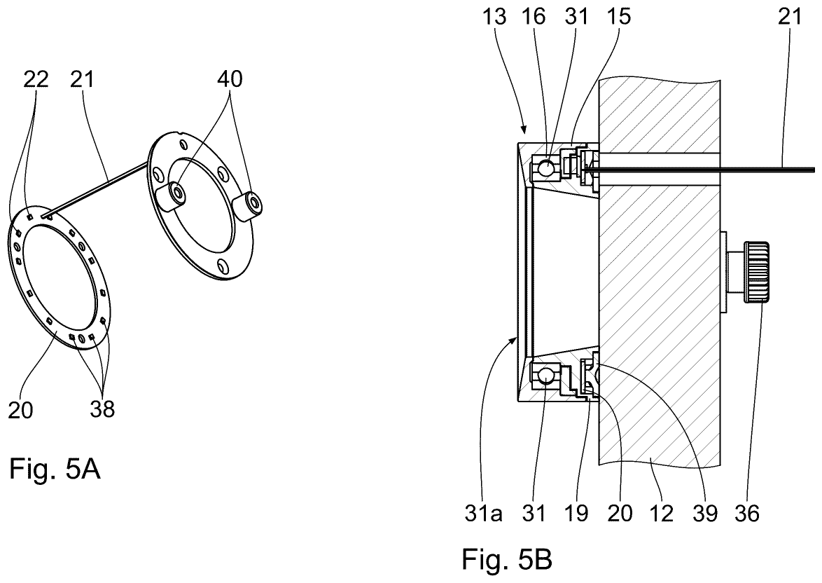

FIG. 5A is a perspective view of part of the operating device of FIG. 4,

FIG. 5B is a sectional view of the operating device along the section line VB-VB of FIG. 4,

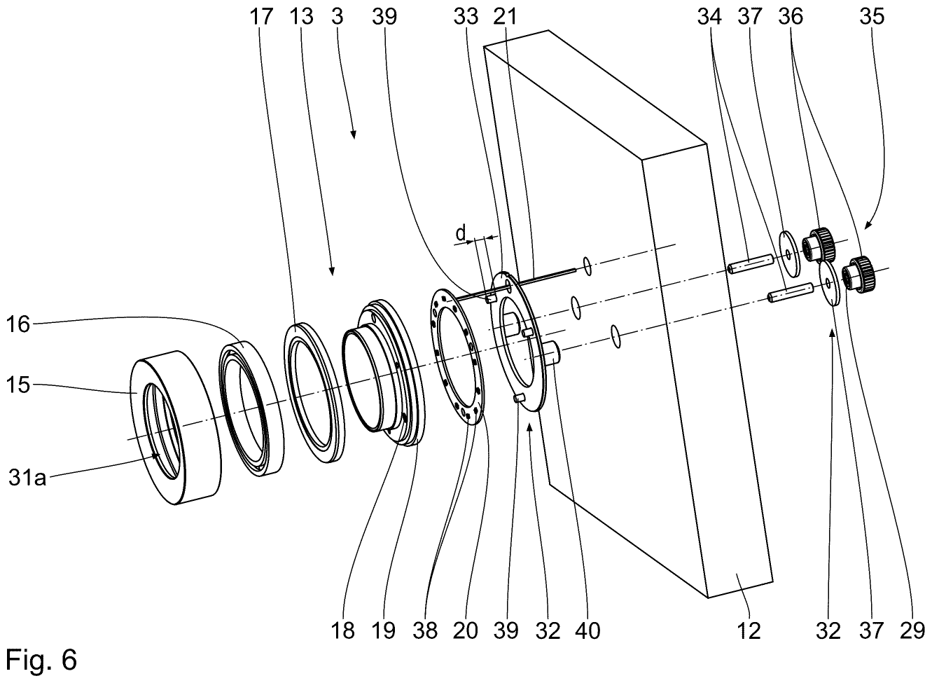

FIG. 6 is an exploded view of an operating device according to a further embodiment,

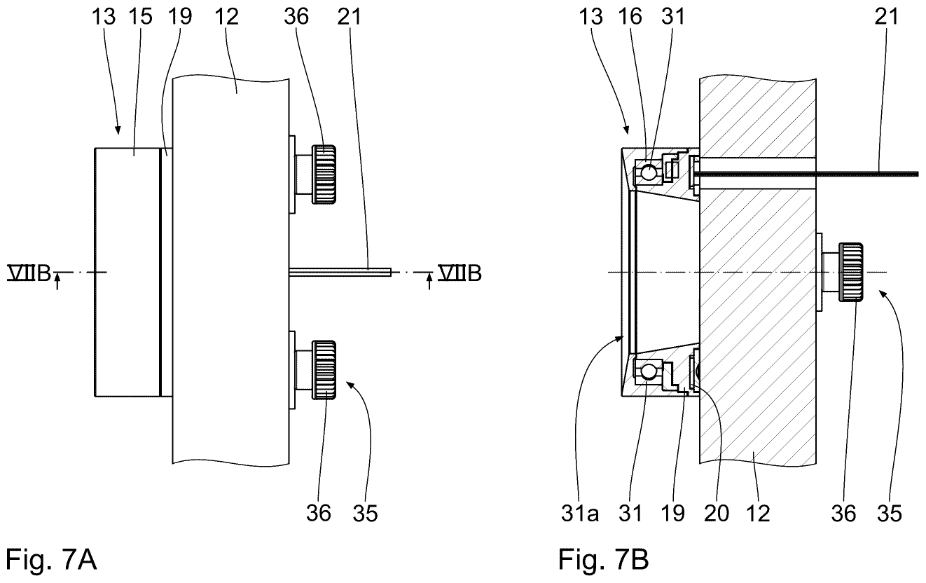

FIG. 7A is a side view of the operating device of FIG. 6, on a kitchen base unit, in particular on a kitchen front,

FIG. 7B is a sectional view of the operating device along the section line VIIB-VIIB in FIG. 7A,

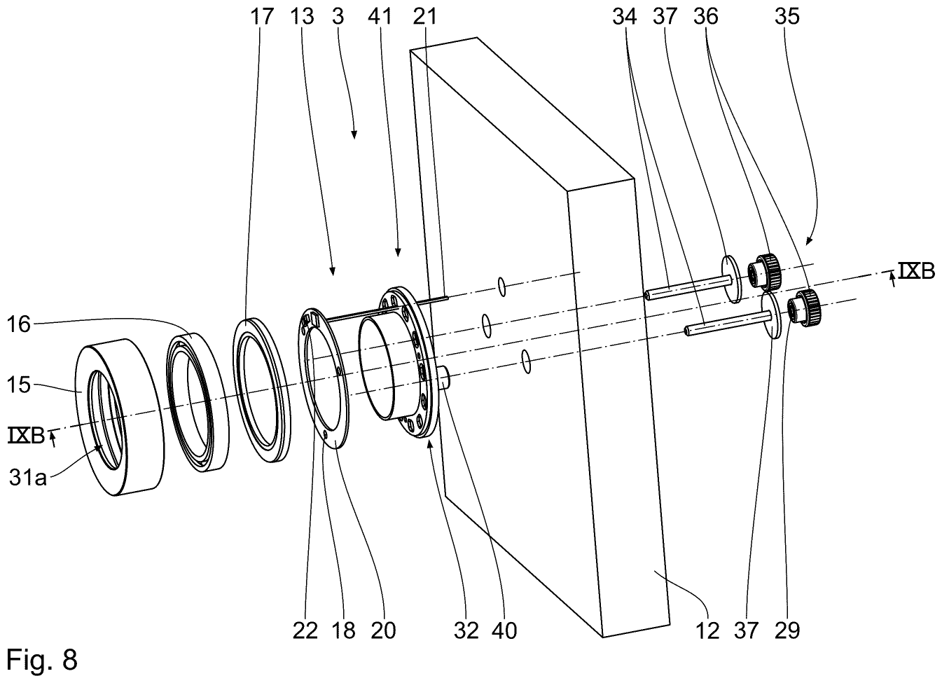

FIG. 8 is an exploded view of an operating device according to a further embodiment,

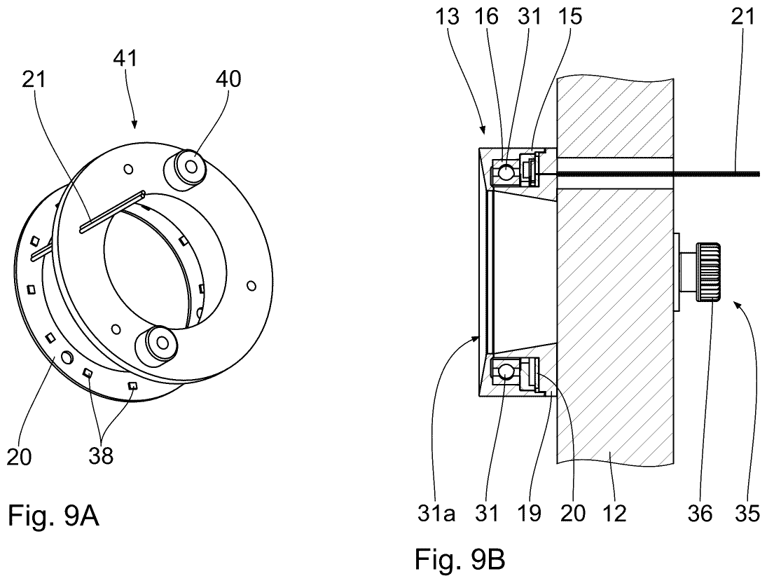

FIG. 9A is a perspective view of part of the operating device of FIG. 8,

FIG. 9B is a sectional view of the operating device along the section line IXB-IXB in FIG. 8,

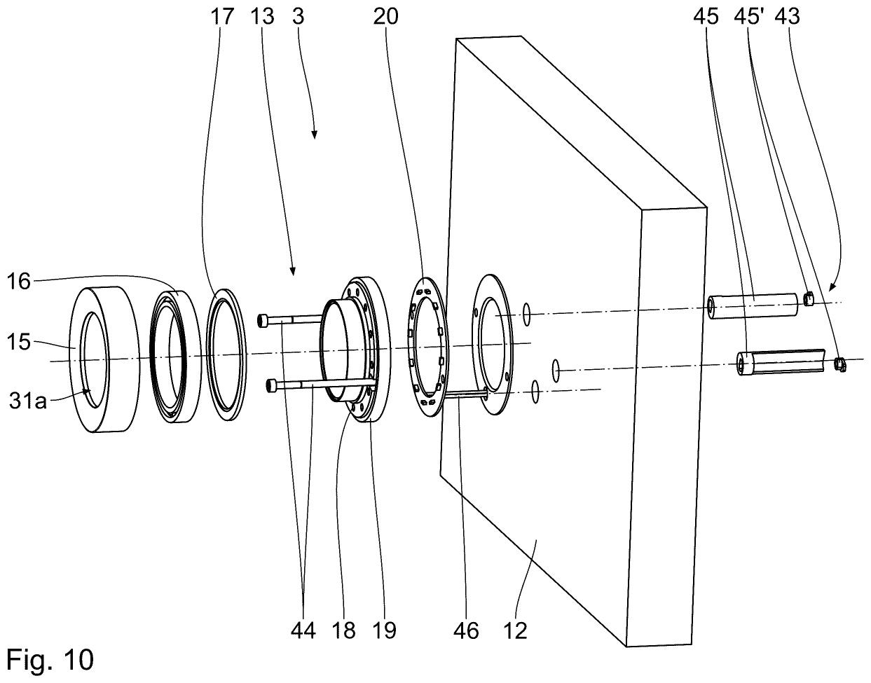

FIG. 10 is an exploded view of an operating device according to a further embodiment,

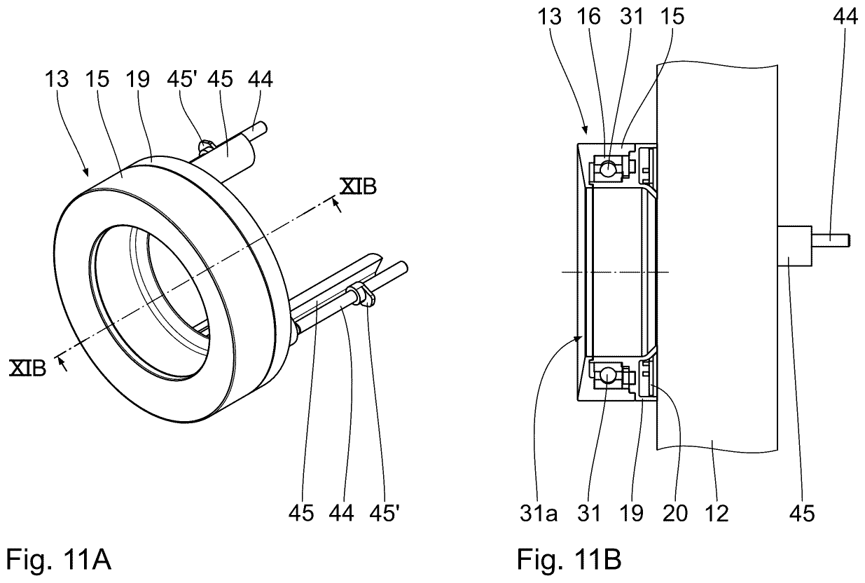

FIG. 11A is a perspective view of the operating device of FIG. 10,

FIG. 11B is a sectional view of the operating device along the section line XIB-XIB in FIG. 11A,

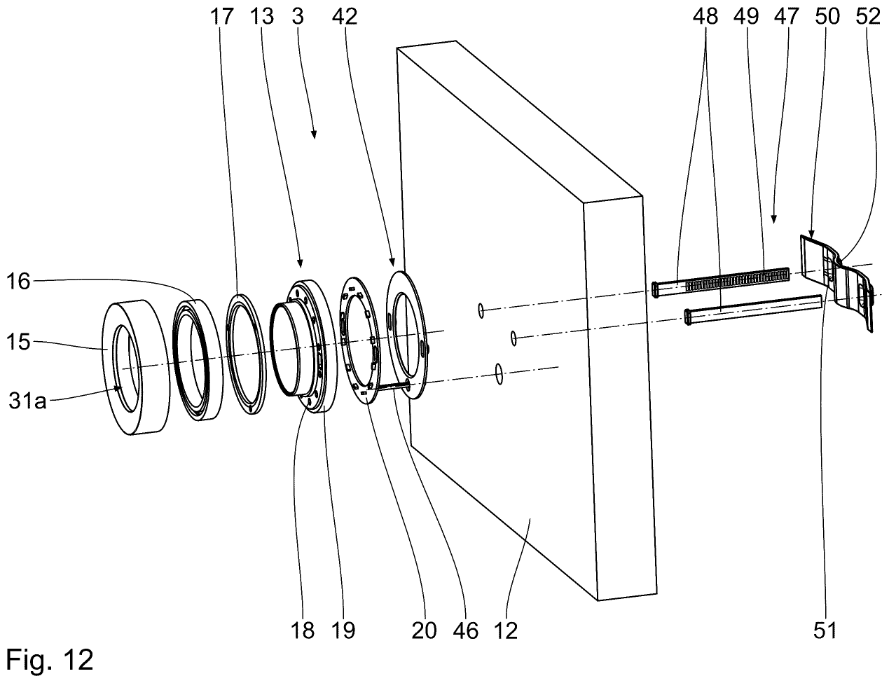

FIG. 12 is an exploded view of an operating device according to a further embodiment,

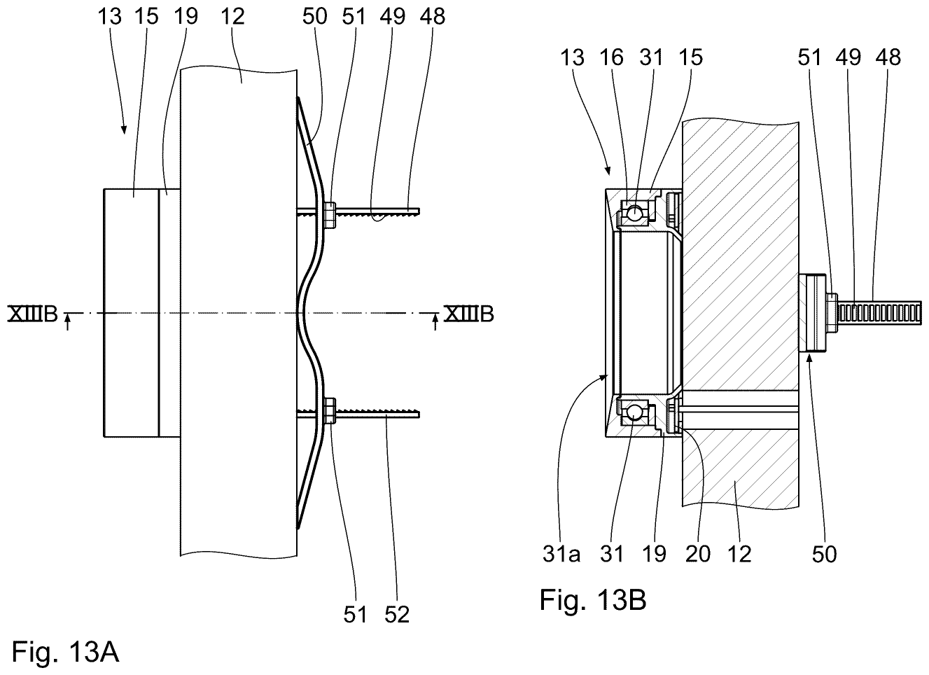

FIG. 13A is a side view of the operating device of FIG. 12,

FIG. 13B is a sectional view of the operating device along the section line XIIIB-XIIIB in FIG. 13A,

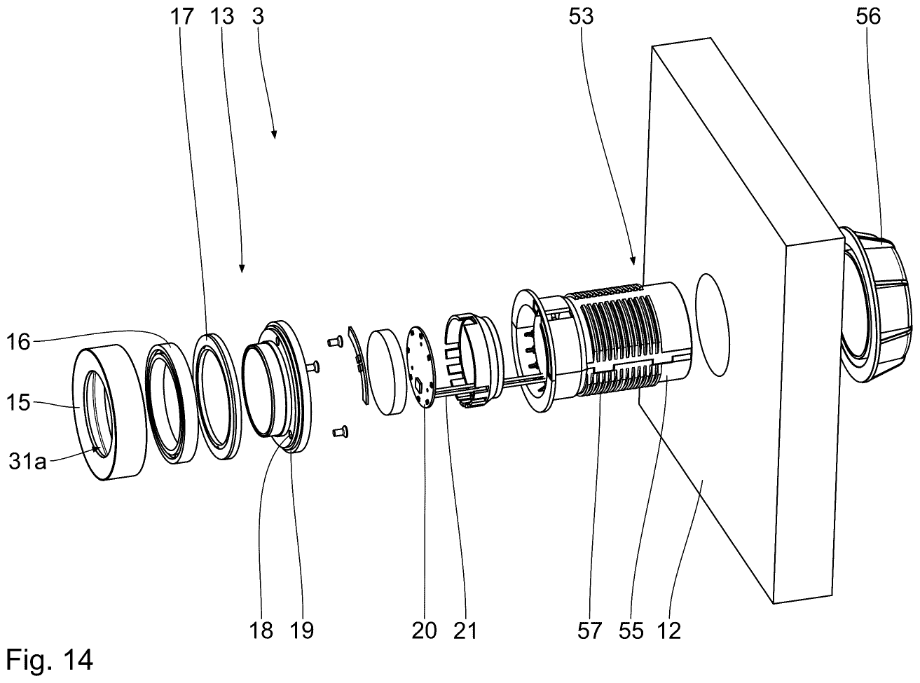

FIG. 14 is an exploded view of an operating device according to a further embodiment,

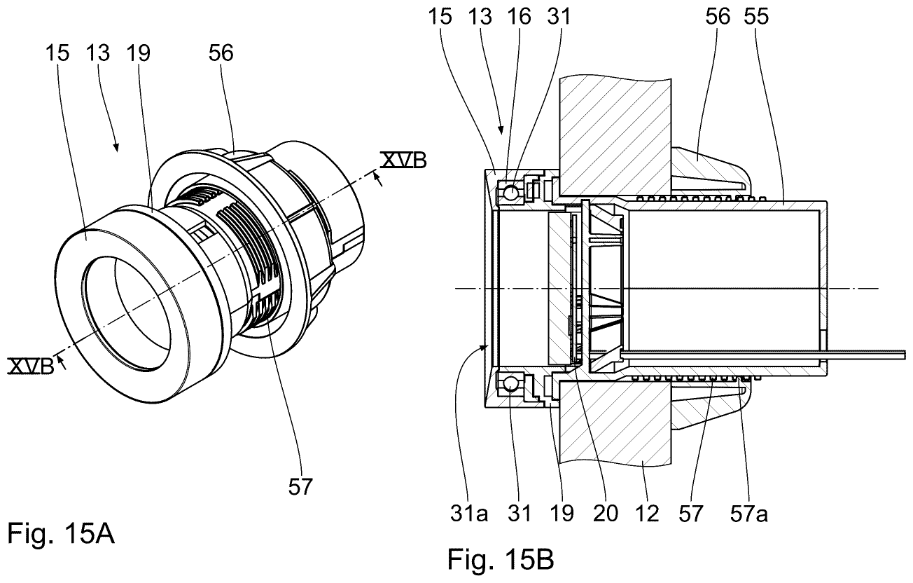

FIG. 15A is a perspective view of the operating device of FIG. 14,

FIG. 15B is a sectional view of the operating device along the section line XVB-XVB in FIG. 15A,

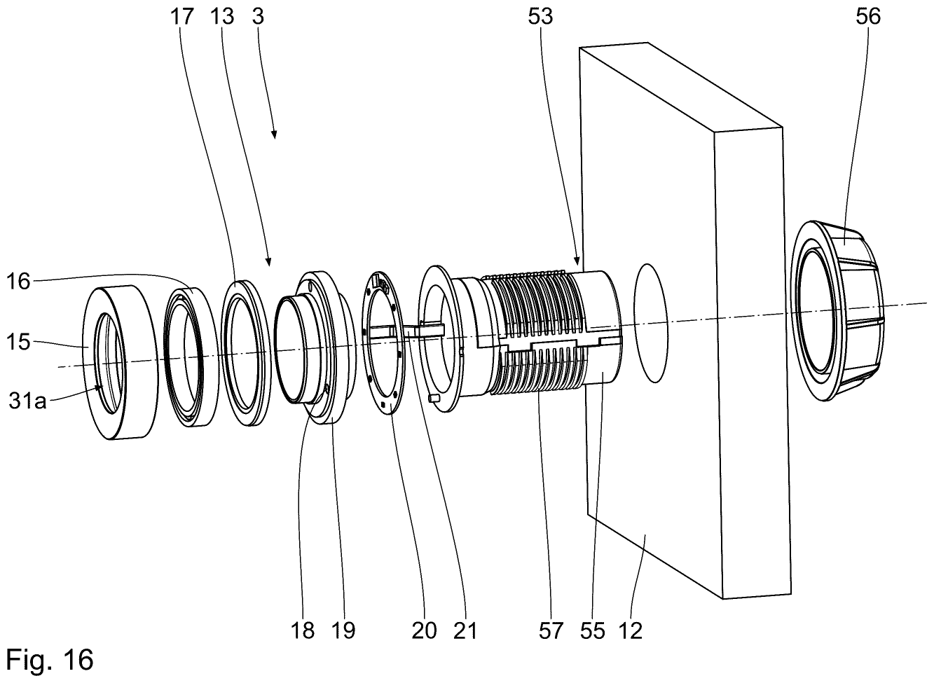

FIG. 16 is a perspective view of an operating device according to a further embodiment,

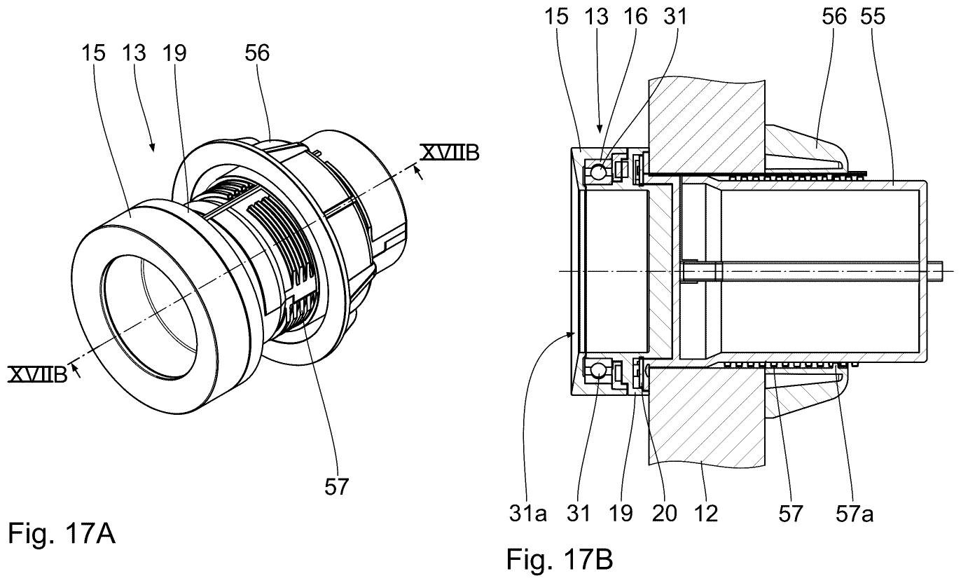

FIG. 17A is a perspective view of the operating device of FIG. 16,

FIG. 17B is a sectional view of the operating device along the section line XVIIB-XVIIB in FIG. 17A,

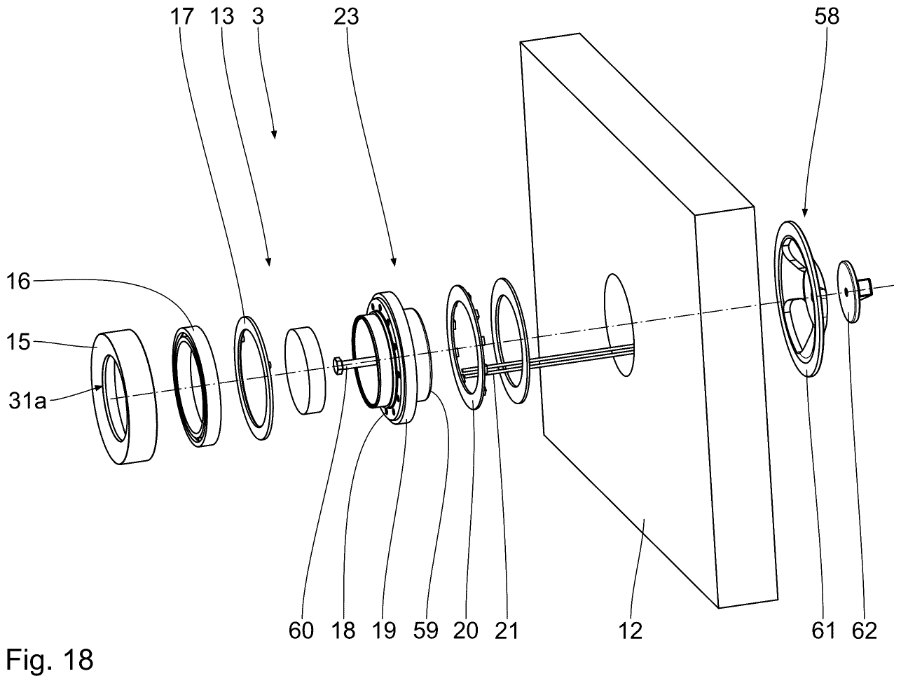

FIG. 18 is a perspective view of an operating device according to a further embodiment,

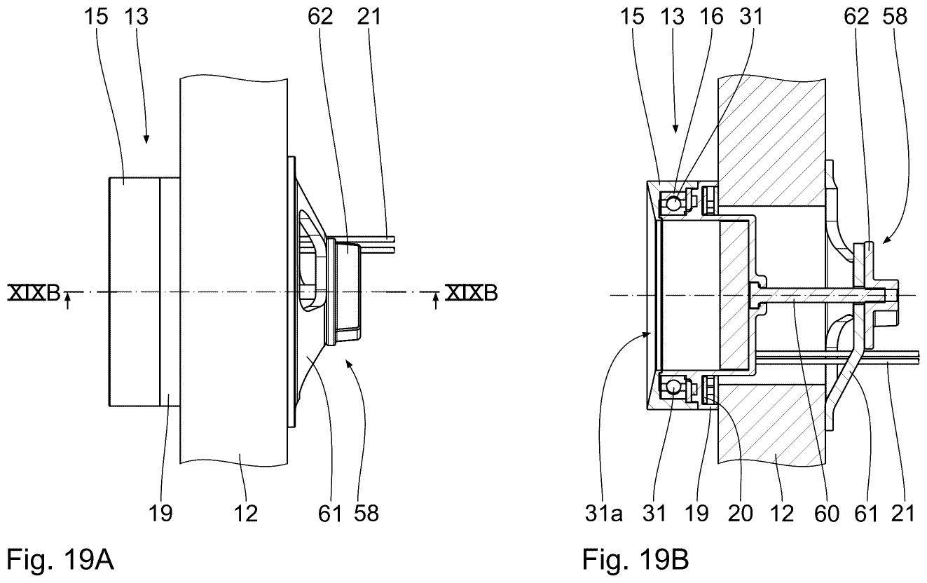

FIG. 19A is a side view of the operating device of FIG. 18,

FIG. 19B is a sectional view of the operating device along the section line XIXB-XIXB in FIG. 19A,

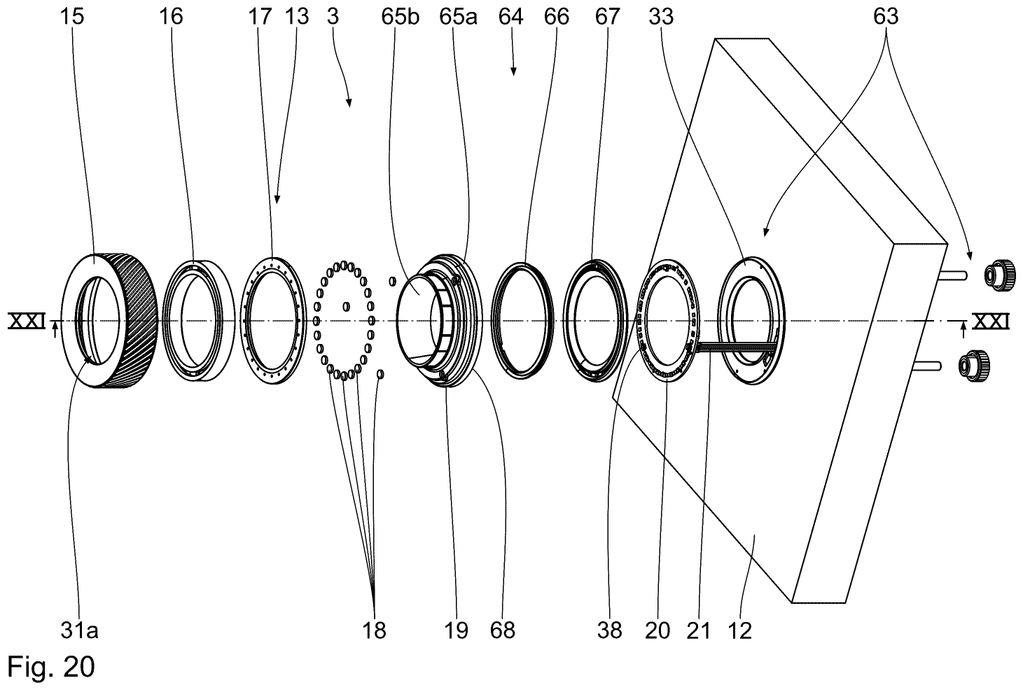

FIG. 20 is a perspective view of an operating device according to a further embodiment,

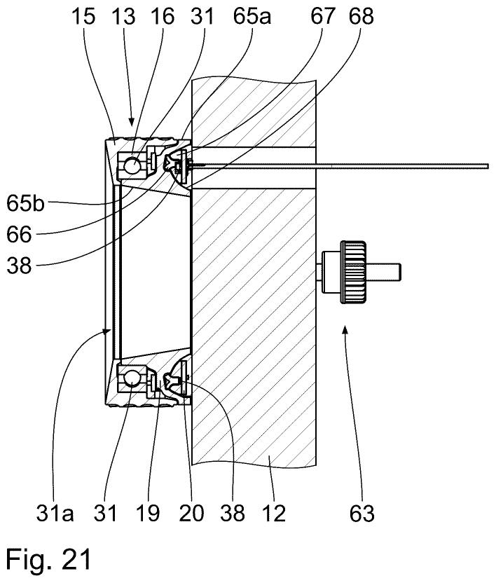

FIG. 21 is a sectional view of the operating device along the section line XXI-XXI in FIG. 20,

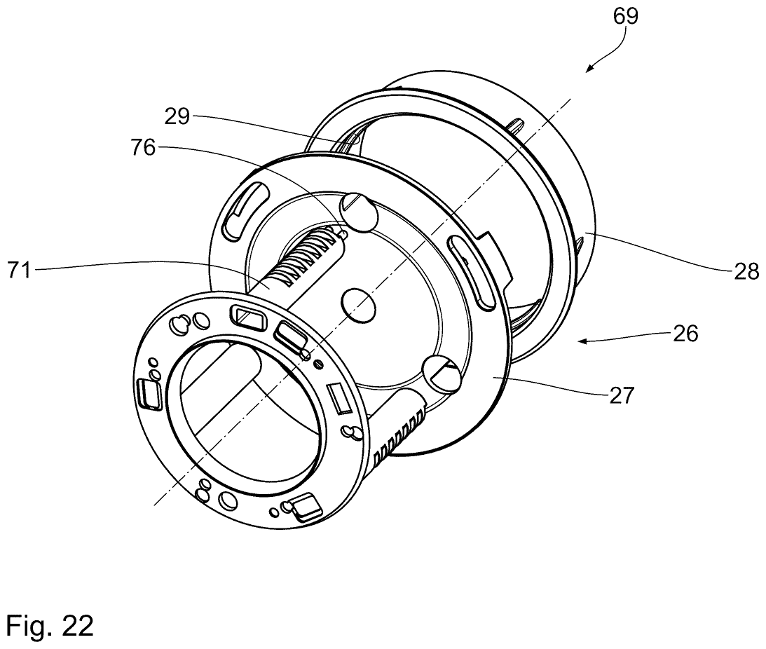

FIG. 22 is a perspective view of a fastening device for an operating device according to a further embodiment,

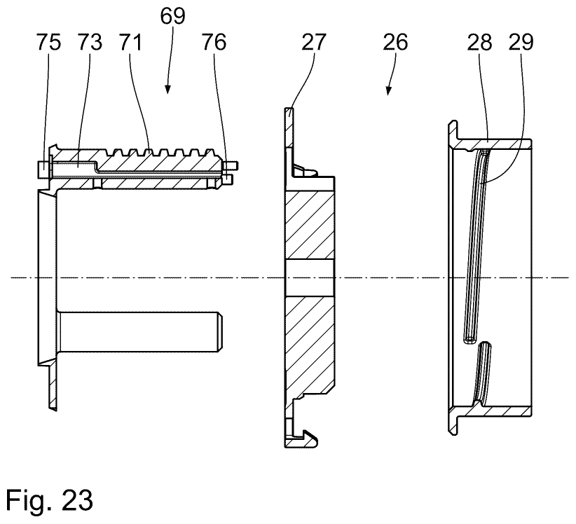

FIG. 23 is a sectional view of the fastening device along the section line XXIII-XXIII in FIG. 22,

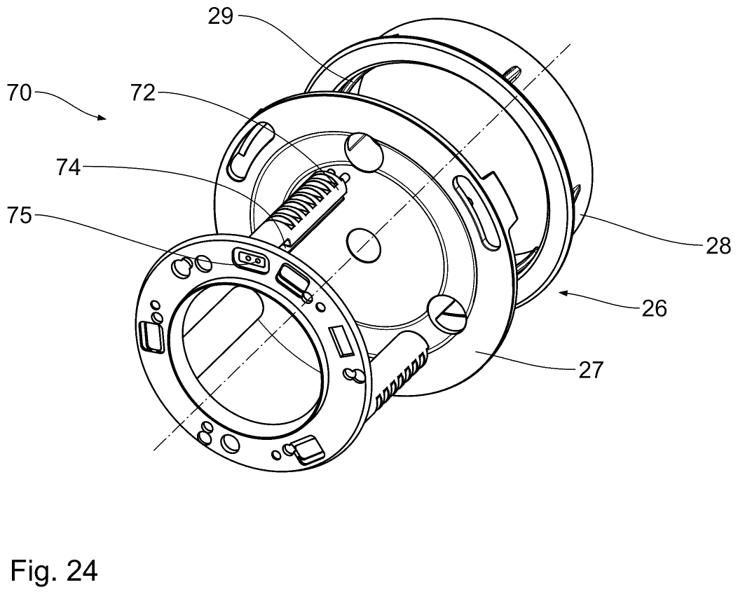

FIG. 24 is a perspective view of a fastening device for an operating device according to a further embodiment, and

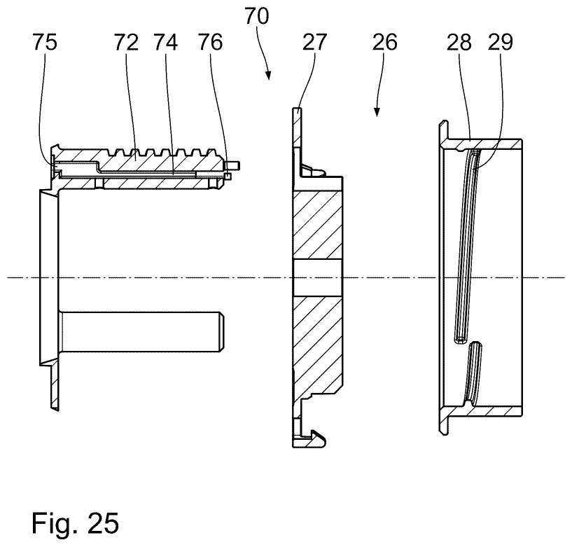

FIG. 25 is a sectional view of the fastening device along the section line XXV-XXV in FIG. 24.

In the following, the general components of a kitchen appliance, in particular in the form of a hob system, in particular a hob extractor system 1, are initially described. The hob extractor system 1 comprises at least one hob 2. In the hob extractor system 1 shown by way of example in FIG. 1, two hobs 2, preferably each with two cooking zones, are provided.

The hobs 2 may be substantially any type of hob. They may include in particular induction hobs, gas hobs, teppanyaki hobs, wok hobs, electric hobs or hot plates, grills or other hobs.

In the alternative shown by way of example in FIG. 1, operating devices, in particular control knobs 3, are provided for operating each of the hobs 2. Operation by means of touch-sensitive sensors, which may in particular be integrated into the hobs 2, is also possible. Operation via a separate operating module is also conceivable. In this case, the hobs 2 may be configured to be non-autonomous, in other words without their own control electronics. This can simplify the structure of the hobs 2. In particular, it is possible to reduce the overall height of the hobs 2. This may in particular be at most 10 cm, in particular at most 6 cm, in particular at most 5 cm, in particular at most 4 cm, in particular at most 3 cm, in particular at most 2 cm.

Furthermore, the hob extraction system 1 comprises a downdraft extractor 4. The downdraft extractor 4 forms a device for extracting cooking fumes.

The downdraft extractor 4 is arranged between the two hobs 2. It may also be arranged to the side of the hobs 2 or in the region behind the hobs 2.

The downdraft extractor 4 has a cooking fume inlet opening 5. In the alternative shown, the cooking fume inlet opening 5 is elongate, in particular rectangular. The cooking fume inlet opening 5 has in particular an aspect ratio of at least 2:1, in particular at least 3:1, in particular at least 5:1, in particular at least 10:1. Typically, the aspect ratio of the cooking fume inlet opening 5 is at most 100:1, in particular at most 50:1.

The cooking fume inlet opening 5 may also be round, in particular circular.

A plurality of cooking fume inlet openings 5 may also be provided. In particular, it is possible to provide two or more cooking fume inlet openings 5, in particular slit-shaped cooking fume inlet openings 5. These may in particular be aligned mutually parallel.

The cooking fume inlet opening 5 may be reversibly closable, in particular by means of a closure element 6. If there are a plurality of cooking fume inlet openings 5, these may each be reversibly closable separately, in other words independently of one another, by means of closure elements 6.

A further control knob 3 is provided for operating the downdraft extractor 4. Operation by means of a touch-sensitive sensor is also possible.

The downdraft extractor 4 is arranged in particular in the region of a cooking surface 8. It is for extracting cooking fumes from the region above the cooking surface 8 to a region below the cooking surface 8. It is therefore also referred to as a downdraft system (downward extraction, in particular through the cooking fume inlet opening 5).

The cooking fume inlet opening 5 is preferably arranged stationary relative to the cooking surface plane 8.

In an alternative not shown in the drawings, the region of the downdraft extractor 4 with the cooking fume inlet opening 5 can be displaced in a direction perpendicular to the hob plane 8.

In principle, the hob extraction system 1 may also include an extractor hood.

The hob system 1 may be configured as an assembly unit. In this case, one or more hobs 2 with one or more downdraft extractors 4 are integrated into a single system. They are in particular arranged in a shared housing. For installation, said housing simply needs to be inserted into a clearance in a worktop 9.

In the region below the hob system 1, compartments, in particular drawers 10 of a kitchen base unit 11, can be used substantially without limitation.

The hob system 1 is modular. In this case, substantially freely selectable hobs 2 can be combined flexibly with one or more of the downdraft extractors 4. In particular, all of the hobs 2 can be operated, in other words controlled, using control knobs 3, which are described in greater detail in the following. The downdraft extractor(s) 4 may also be operable, in other words controllable, using control knobs 3.

The control knobs 3 are also modular. They are each connected to one of the hobs 2 and/or to the downdraft extractor 4 via an interface 12. In particular, they are signal-connected to one of the plurality of hobs 2 and/or downdraft extractors 4.

The control knobs 3 are in particular standardised. This means that the same control knob 3 is suitable for operating different hobs 2 and/or downdraft extractors 4. The control knobs 3 are self-configuring. This means that, when one of the hobs 2 and/or downdraft extractors 4 is connected, they automatically recognise which built-in kitchen appliance is involved and their functionality is adjusted accordingly.

A uniform, standardised configuration of this type of the control knobs 3 facilitates their manufacture. Furthermore, this allows for easy interchangeability of the control knobs 3. Ultimately, this simplifies the assembly of the hob extractor system 1.

In the following, different variants of the control knob 3 are described with reference to FIGS. 2 to 21. In all variants, the control knob is referenced using the reference symbol 3. In the different variants, like components have like reference numbers and, for reasons of efficiency, are not described repeatedly.

In the first variant, disclosed with reference to FIG. 2 to FIG. 3B, the control knob 3 comprises an operating element 13 and a fastening device 14.

The operating element 13 comprises a knob cover 15. The operating element 13 comprises a ball bearing 16. The operating element 13 comprises a magnet recess 17. The operating element 13 comprises at least one magnet 18. The operating element 13 comprises a housing 19. The operating element 13 comprises a circuit board 20.

A cable 21 for transmitting electrical and/or control signals from the control knob 3 to the hob system 1 is connected to the circuit board 20. In particular, the information transmission may be bidirectional.

The circuit board 20 also has electrical components 22 arranged on the circuit board 20. The electrical components 22 include in particular components for operating the hob system 1 and/or lighting means, in particular LED lighting means. The circuit board 20 is in particular circular and annular.

The circuit board 20 has in particular an outer radius R and an inner radius r. For the outer radius, in particular 1 cm≤R≤5 cm, in particular 2 cm≤R≤4 cm, in particular 2.5 cm≤R≤3.5 cm, and in particular R=3 cm.

For the inner radius r, in particular 0.5 cm≤r≤4.5 cm, in particular 1.5 cm≤r≤3.5 cm, in particular 2 cm≤r≤3 cm and in particular r=2.5 cm.

The knob cover 15 is circular and annular. In particular, the knob cover 15 has an opening passing through in the axial direction. The opening has a radius whose length is in particular at least 70%, in particular at least 75%, and in particular at least 80% of the length of a radius of the knob cover 15. The knob cover 15 is configured to enclose and cover the remaining components of the operating element 13. The knob cover represents in particular the outermost part of the operating element 13, with which a user directly cooperates.

The knob cover 15 may be made at least in part from a transparent and/or semi-transparent, in particular milky, material, in particular a plastics material, which is translucent in particular to light from an LED. In particular, the material of the knob cover 15 may be translucent to red light and/or blue light and/or white light and/or light across the entire light spectrum perceptible to humans. In particular, it is possible for a control knob 3 equipped with red lighting to be used to operate a hob, while a control knob 3 equipped with blue lighting is used to operate the downdraft extractor 4.

It is also possible for the knob cover 15 to be made of metal.

The ball bearing 16 is in particular for accommodating at least one ball 31 (see FIG. 3), via which the knob cover 15 is mounted rotatably. The ball bearing 16 may in particular be configured as a deep groove ball bearing.

The magnet recess 17 is for mounting the at least one magnet 18. In particular, it is possible for the magnet mounting 17 to be for mounting more than one magnet 18, in particular at least two, in particular at least three, in particular at least five, in particular at least seven, in particular at least ten, in particular at least twelve and in particular at least fifteen magnets 18.

By means of the magnets 18, it is possible to detect an angle of rotation through which a user has turned the control knob 15. Detecting this angle of rotation makes it possible to activate and/or deactivate and/or change the system parameters of the hob 2 and/or the downdraft extractor 4. The changing magnetic signal can be detected by electrical components 22 of the circuit board 20 and transmitted to the hob system 1 via the cable 21.

The remaining components of the operating element 13 are arranged or mounted on the housing 19. The housing 19 is enclosed at least in part by the knob cover 15. The circuit board 20 is arranged in particular on the lower face of the housing 19, in other words the face facing the furniture front 12.

The fastening device 14 comprises a fastening element 23 with a total of three pin-shaped elements 24. In particular, it is possible for the fastening element 23 to have a different number of pin-shaped elements 24. For example, it is possible for the fastening element 23 to have at least two, in particular at least four and in particular at least five pin-shaped elements.

The fastening element 23 is also circular and annular. The pin-shaped elements 24 extend from the circular annular fastening element 23 in the direction of the furniture front 12. The pin-shaped elements 24 are in particular uniformly distributed over the fastening element 23. In particular, in the variant described in FIGS. 2 to 5, the pin-shaped elements 24 are at a phase of 120 ° C. to one another. With a uniform distribution, n pin-shaped elements 24 may in general be at a phase of 360°/n to one another. It is also possible for the pin-shaped elements 24 to be non-uniformly distributed over the circular annular fastening element 23.

The pin-shaped elements 24 each have at least one partially threaded portion 25. It is also possible for the pin-shaped elements 24 to have at least two and in particular at least three partially threaded portions 25. In the present variant, the pin-shaped elements 24 have three partially threaded portions 25, which each extend on a face of the pin-shaped element 24 along the entire length of the pin-shaped element 24 and are identical to one another.

The pin-shaped elements 24 are intended to pass through the furniture front 12 and cooperate with at least one fixing means 26 on the other face of the furniture front 12, in such a way that the control knob 3 is held on and in particular fastened to the kitchen front 12. For this purpose, it is possible in particular to create, in the kitchen front 12, through-holes, for example pre-drilled ones, through which the pin-shaped elements 24 can be guided.

In particular, it is possible for at least one of the pin-shaped elements 24 to be hollow, in particular so as to guide the cable 21 of the circuit board 20 to the hob system 1.

The fixing means 26 comprises a support element 27 and a nut 28. The nut 28 may in particular be configured as a union nut.

The support element 27 has a plurality of recesses in which the pin-shaped elements 24 can be mounted movably in the axial direction. The support element 27 is in particular for mounting the pin-shaped elements 24 immobilised in the radial direction. In this way, the pin-shaped elements 24 can be prevented from being bent inwards, in other words towards the centre of the circular ring of the fastening element 23.

The nut 28 has in particular at least one threaded fixing portion 29. In particular, it is possible for the nut 28 to have more than one threaded fixing portion 29. The nut 28 has in particular exactly as many threaded fixing portions 29 as the pin-shaped elements 24 have partially threaded portions 25. The threaded fixing portions 29 are in particular configured so as to cooperate with the partially threaded portions 25 to fasten the control knob 3 non-positively to the furniture front 12.

The fastening device 14 further comprises three screws 30 by means of which the operating element 13 can be connected non-positively to the fastening element 23.

The operating device 3, in particular the operating element 13 and the fastening device 14, has a central clearance 31a. The central clearance 31a is formed on the front face of the operating device 3 in such a way that the kitchen furniture 11, in particular the furniture front 12, is uncovered by the operating device 3 in a front view.

The central clearance 31a is preferably circumferentially delimited, in particular enclosed, by the operating device 3, in particular the operating element 13 and/or the fastening device 14. For this purpose, the operating device 3 may at least in portions, in particular the operating element 13 and/or the fastening device 14 may, be annular, in particular circular and annular.

A further variant of the control knob 3 is shown in FIGS. 4 to 5B. In this variant, the control knob 3 comprises the operating element 13, which is identical to the operating element 13 of the control knob 3 of the first variant, and a fastening device 32.

The fastening device 32 comprises a guide ring 33, at least two pin-shaped elements 34 and a fixing means 35.

The guide ring 33 is circular and annular and has at least two recesses in which the pin-shaped elements 34 engage so as to fasten the guide ring 33 positively to the furniture front 12 in cooperation with the fixing means 35.

It is also possible in this variant for more than two pin-shaped elements 34 to be used. The pin-shaped elements 34 may in particular have at least two partially threaded portions (not shown in FIGS. 6 to 8). In particular a first partially threaded portion may cooperate with a threaded fixing portion 29 (not shown in FIGS. 6 to 8) of the recesses of the guide ring 33 so as to connect the guide ring 33 non-positively to the pin-shaped elements 34.

The furniture front 12 has through-openings, for example in the form of through-holes, through which the pin-shaped elements 34 and at least in part the recesses of the guide ring 33 are guided.

The second partially threaded portion of the pin-shaped elements 34 is in particular for cooperating with the fixing means 35 so as to fasten the guide ring 33, and thus also the operating element 13 and the control knob 3, non-positively to the furniture front 12.

The fixing means 35 comprises in particular a nut 36 and a washer 37. The nut 36 comprises a threaded fixing portion 29.

To fasten the guide ring 33 to the furniture front 12, first the washer 37 and then the nut 36 may be attached to, in particular screwed onto, the end of the pin-shaped element 34 remote from the operating element 13. The washers 37 are in particular for ensuring particularly uniform force transmission from the nuts 36 to the furniture front 12.

The guide ring 33 also has a through-hole so as to guide the cable 22 from the circuit board 20 to the hob system 1.

In both the first variant (FIGS. 2 to 3B) and the second variant (FIGS. 4 to 5B), the circuit board 20 is positioned directly on the guide ring 33 or fastening element 23. In particular, the circuit board 20 and the guide ring 33 or fastening element 23 are arranged without any axial spacing from one another. FIG. 9 shows an alternative embodiment of the guide ring 33 and circuit board 20. It should be noted in particular that the following explanations with reference to FIG. 9 do not only relate to the arrangement of a circuit board 20 and a guide ring 33 with respect to one another, but are also transferrable to the positioning of a circuit board 20 and a fastening element 23 relative to one another.

The guide ring 33 comprises at least one elevation 39. In particular, the guide ring 33 comprises three elevations 39. It is also possible for the guide ring 33 to have more than three elevations 39.

The circuit board 20 is arranged on the elevations 39, in such a way that a distance d is established between the guide ring 33 and the circuit board 20. For the distance d, it may in particular be the case that 1 mm≤d≤10 mm, in particular 2 mm≤d≤9 mm, in particular 3 mm≤d≤7 mm and in particular d=5 mm.

As a result of the distance d, in particular light from lighting means 38, which may be arranged on the circular annular circuit board 20, can be reflected, in particular diffusely reflected. In this way, the radiation characteristic of the lighting means 38 and in particular the lighting of the control knob 3 can be improved. For example, the operating device 3, in particular the circuit board 20 and/or the fastening element 23, may have a reflector for light, in particular the light emitted by the lighting means 38.

The operating element 13 has means 40 for receiving the pin-shaped elements 34, which are preferably part of a housing 42 of the operating element 13. Furthermore, in this variant, means for detecting the angle of rotation of the knob cover 15 and means for rotatably mounting the knob cover 15 are already integrated into the housing 42. A housing 42 of this type may also in particular be combined with a fastening element 23 according to the above variants.

FIGS. 6 to 9B show two further variants of a control knob 3. The control knob 3 comprises an operating element 13 and a fastening device 41.

In the variants shown in FIGS. 6 to 9B, the fastening device 41 comprises the pin-shaped elements 34 and fixing means 35, the precise function of which has already been explained with reference to FIGS. 4 to 5B. In this variant, the fastening device 41 does not comprise a guide ring, since the means for receiving the pin-shaped elements 34 are already integrated into the housing 42.

In a further variant of the control knob 3, shown in FIGS. 10 to 11B, the control knob 3 comprises a fastening device 43. The fastening device 43 comprises at least two pin-shaped elements 44, at least two cavity wall boxes 45 and at least two retaining clips 45′.

The pin-shaped elements 44 are in particular directly connected to the housing 19 of the operating element 13.

The fastening device 43 comprises at least two cavity wall boxes 45, which are inserted into prefabricated through-openings in the furniture front 12. The pin-shaped elements 44 are arranged in the cavity wall boxes 45 and are respectively clamped into the cavity wall boxes 45 by means of the retaining clips 45′ and thus positively mounted. The fastening device 43 further comprises a cable duct 46, which may for example be made of Plexiglas. The cable duct 46 is for guiding the cables 21 from the circuit board 20 to the hob system 1.

In a further variant of the control knob 3, shown in FIGS. 12 to 13B, the control knob 3 comprises a fastening device 47, at least two pin-shaped elements 48 with a toothing 49, and a fixing means 50.

The pin-shaped elements 48 are configured as flat strips. The toothing 49 is arranged in particular on the inner face of the pin-shaped elements 48, in other words on the face associated with the centre of the circular annular control knob 3. It is possible for the fastening device 47 to have more than two pin-shaped elements 48.

In the present case, the fixing means 50 is configured as a strip-shaped, curved counter holder and/or as a spring, in particular as a wave spring. Other configurations of the fixing means 50 are also possible. The fixing means 50 may for example be formed in a single piece or consist of multiple parts.

The fixing means 50 comprises at least one recess 51 in which a latch element 52 is arranged. The latch element 52 is preferably configured as a spring tongue, in particular in the manner of the spring tongue of a cable tie. In particular, it is possible for the fixing means 50 to have exactly as many recesses 51 with associated latch elements 52 as there are pin-shaped elements 48.

The latch element is for cooperating with the toothing 49 of the pin-shaped element 48 and holding the pin-shaped element 48 positively in the recess. The basic operating principle of the pin-shaped elements 48 and the fixing means 50 corresponds to that of a conventional commercial cable tie. In particular, it is possible to push the pin-shaped elements as far as desired into the recess 51 along the direction from the control knob 3 to the furniture front 12. The latch element 52 prevents the pin-shaped elements 48 from being pulled out of the recess 51 in the opposite direction. In this way, the control knob 3 can be attached to the furniture front 12 securely and in particular in a time-efficient manner. In particular, it is possible for the fixing means 50 to have means (not shown in FIGS. 13 and 14) for adjusting the latch element 52 in such a way that the pin-shaped elements 48 can be pulled out of the recesses 51.

In this way, the fastening of the control knob 3 to the furniture front 12 can be made easily reversible. In particular, reversibly fastening the control knob 3 to the furniture front 12 in this manner makes particularly time-efficient maintenance and/or installation of the hob system 1 and in particular of the control knob 3 possible.

In a further variant of the control knob 3, shown in FIGS. 14 to 15B, the control knob 3 comprises a fastening device 53.

The fastening device 53 comprises a pin-shaped element 55 and a lock nut 56. In the present variant, the pin-shaped element 55 has a diameter substantially in the region of the diameter of the control knob 3. The pin-shaped element is in particular directly connected to the housing 19 of the control knob 3.

To fasten the control knob 3, a hole for accommodating the pin-shaped element 55 must be made in the furniture front 12. The hole has a diameter substantially in the region of the diameter of the control knob 3. The pin-shaped element then has a partially threaded portion 57, which cooperates with a threaded fixing portion 57a of the lock nut 56 to fasten the control knob 3 to the furniture front 12.

In the present variant, the cable 21 of the circuit board 20 is routed directly within the one pin-shaped element 55 from the circuit board 20 to the hob system 1. The circuit board 20 is circular.

In a further embodiment, shown in FIGS. 16 to 17B, the circuit board 20 is circular and annular. Otherwise, the structure of the control knob 3 substantially corresponds to that of the control knob 3 disclosed in FIGS. 14 to 15B.

In a further variant of the control knob 3, shown in FIGS. 18 to 19B, the control knob 3 has a fastening device 58.

The fastening device 58 comprises a fastening element 59, a pin-shaped element 60, a fastening disc 61 and a fastening knob 62.

The fastening element 59 has a recess for mounting the pin-shaped element 60. The components of the operating element 13, in particular the housing 19, are directly connected to the fastening element 59. A connection of this type may for example be made by means of screws (not shown in FIGS. 17 and 18).

The pin-shaped element 60 is connected centrally to the fastening element 59. This means that the pin-shaped element is arranged in the region of the centre point of the circular annular control knob 3. The pin-shaped element extends through the furniture front 12 in the axial direction.

For this purpose, a through-opening needs to be made in the furniture front 12, and, as was also previously the case for the variant explained with reference to FIGS. 15 and 16, has a diameter substantially in the region of the diameter of the control knob 3, since the fastening element 59 is also arranged at least in part within this through-opening.

The pin-shaped element 60 passes through a recess of the fastening disc 61 on the face of the furniture front 12 remote from the operating element 13 and is secured by tightening the fastening knob 62. By way of the tightening of the fastening knob 62 and the cooperation of the fastening disc 61 and fastening element 59, the control knob 3 is firmly fastened to the furniture front 12. The cable 21 of the circuit board 20 is routed directly in the aforementioned through-hole.

In principle, different variants of bearing and latch concepts for the knob cover 15 are possible and are provided.

The variant shown in FIG. 19A substantially corresponds to the variants of the operating device 13 already discussed, with reference to the previous drawings.

For example, the control knob 3 may comprise an operating element 13 in which the knob cover 15 is locked and/or mounted by means of axial ball thrust pieces. By way of the ball thrust pieces, the angle of rotation of the knob cover 15, and thus the operation of the control knob 3, can be established and, once detected by means of corresponding electronic components 22 on the circuit board 20, transmitted to the hob system 1.

Latching of a rotation angle when the knob cover 15 is rotated may alternatively or additionally be implemented by means of the magnets 18. The magnets 18 can form a magnet mounting.

Radial ball thrust pieces may be used both for mounting the knob cover 15 and for locking a rotation of the knob cover 15.

In a further variant of the operating device 3, described with reference to FIGS. 20 and 21, it has a fastening device 63. This largely corresponds in structure to the fastening device 32, although other configurations, in particular according to the example embodiments described above, are also possible.

What is special is that the operating device 3 has a light guide device 64 for guiding the light between the at least one lighting means 38 and at least one light exit surface 65a, 65b of the operating device 3. The light guide device 64 preferably comprises a first light guide body 66 and/or a masking means 67 and/or a second light guide body 68. The aforementioned components 66, 67, 68 are preferably annular.

The at least one light guide body 66, 68 may be configured as a light splitter, in particular in a switch shape and/or in a y shape and/or as a prism. Preferably, the at least one light guide body 66, 68 comprises a translucent material, in particular a plastics material.

The masking means 67 may comprise an opaque plastics material. The masking means 67 preferably encloses the at least one light guide body 66, 68 at least in portions, in particular over the majority of its surface.

Preferably, the light guide device 64 is configured in such a way that the light emitted by the at least one lighting means 38 is emitted inwards and outwards, in particular with respect to an annular component of the operating device 3, in particular at the light exit surfaces 65a, 65b, in particular at the inner and/or outer surfaces of the light guide 68.

In two further variants, described with reference to FIGS. 22 to 25, the fastening device 69, 70 may have at least one pin-shaped element 71, 72 with a feedthrough for at least one signal-transmitting element, in particular an elongate circuit board 73, 74. Plug-in connection means 75, 76 may be arranged at both ends of the associated signal-transmitting element 21.

The two embodiments differ in that the circuit board 73 is inserted into the tubular passage frontally, in other words in the longitudinal direction, whereas the circuit board 74 is inserted into the slotted passage laterally, in other words in the transverse direction.

Other fastening concepts for an operating device 3 are also conceivable. In one variant, the guide ring 33 may be fastened directly to the kitchen front 12 by means of screws. The rest of the operating element 13, in particular the housing 19, can then be attached to the guide ring 33 by means of a bayonet lock.

Alternatively, the guide ring 33 may be glued directly to the furniture front 12 by means of an adhesive layer 68.

The guide ring 33 and the housing 19 may be formed as a single-piece component, the housing 19 being attachable directly to the furniture front 12 by means of the screws.

The housing 19 and the guide ring 33 may be formed as a single-piece component which is glued directly to the kitchen front 12 by means of an adhesive layer.

The control knobs 3 disclosed by way of the example embodiments are merely one possible alternative for operating devices 3. The operating device 3 according to the disclosure may alternatively or additionally have a touch-sensitive surface and/or a display element, in particular a screen, in particular a touch-sensitive screen, and/or at least one, in particular a plurality of buttons.

1. An operating device for operating a hob system, comprising:
an operating element; and
a fastening device for fastening the operating element to a kitchen furniture including:
a plurality of pin-shaped elements; and
a fixing device,
wherein a plurality of the pin-shaped elements each have a partially threaded portion,
wherein the fixing device comprises a nut with one or more threaded fixing portions which fit to and cooperate with the partially threaded portions.

2. The operating device according to claim 1, wherein the partially threaded portions together form portions of a single thread.

3. The operating device according to claim 1, wherein the partially threaded portions are identically formed.

4. The operating device according to claim 1, wherein the nut has a number and an arrangement of threaded fixing portions matching the number and arrangement of the partially threaded portions.

5. The operating device according to claim 1, wherein the fastening device has at least one feedthrough for a signal-transmitting element, in particular a circuit board.

6. The operating device according to claim 5, wherein the feedthrough is formed in at least one of the pin-shaped elements and/or includes the circuit board arranged therein.

7. The operating device according to claim 1, wherein the fixing device has a support element for supporting the pin-shaped elements.

8. The operating device according to claim 7, wherein the support element is resilient.

9. The operating device according to claim 7, wherein the nut can be latched to the support element.

10. The operating device according to claim 9, wherein the nut is mounted on the support element rotatably relative to the support element.

11. The operating device according to claim 9, wherein the nut is spring-mounted on the support element in a screwing direction.

12. The operating device according to claim 1, wherein a central clearance on a front face of the operating device, the clearance being configured in such a way that the kitchen furniture is uncovered by the operating device in a front view.

13. The operating device according to claim 1, wherein a rotatably mounted component of the operating element is annular.

14. The Operating device according to claim 1, wherein at least one light of which a primary light emission direction points in a direction of a rear face of the operating device.

15. The operating device according to claim 14, wherein at least one reflector for reflecting the light emitted by the at least one light in the direction of a front face of the operating device (3).

16. A hob system comprising the operating device according to claim 1.

17. A unit system, comprising:
a kitchen furniture; and
the operating device according to claim 1 attached to the kitchen furniture, wherein the operating element is fastened to the kitchen furniture, by the fastening device.

18. A method of assembling an operating device for a hob system, comprising:
providing the operating device according claim 1, comprising the fastening device with a plurality of pin-shaped elements; and
drilling holes in a furniture front of a kitchen furniture,
wherein a number and arrangement of the holes correspond to the number and arrangement of the pin-shaped elements of the fastening device.

19. The operating device according to claim 13, wherein the rotatably mounted component of the operating clement includes a knob cover, a light guide body, and/or the fastening device.
